(19) United States
(12) Patent Application Publication
(10) Pub. No.: US 2007/0278151 A1
(43) Pub. Date: Dec. 6, 2007

(54) METHOD OF IMPROVING PERFORMANCE OF ULTRAFILTRATION OR MICROFILTRATION MEMBRANE PROCESSES IN BACKWASH WATER TREATMENT

(76) Inventor: Deepak A. Musale, Aurora, IL (US)

Correspondence Address: NALCO COMPANY, 1601 W. DIEHL ROAD, NAPERVILLE, IL, 60563-1198, US

(21) Appl. No.: 11/421,172

(22) Filed: May 31, 2006

(51) Int. Cl. B01D 65/02

(52) U.S. Cl. 210/636; 210/639; 210/641; 210/650; 210/652

(57) ABSTRACT

A method of processing backwash water by use of a membrane separation process is disclosed. Specifically, the following steps are taken to process backwash water: collecting backwash water in a receptacle suitable to hold said backwash water; treating said backwash water with one or more water soluble polymers, wherein said water soluble polymers are selected from the group consisting of: amphoteric polymers; cationic polymers, wherein, said charge density is from about 5 mole percent to about 100 mole percent; zwitterionic polymers; and a combination thereof; optionally mixing said water soluble polymers with said backwash water; passing said treated backwash water through a membrane, wherein said membrane is an ultrafiltration membrane or a microfiltration membrane; and optionally back-flushing said membrane to remove solids from the membrane surface.

### FIELD OF THE INVENTION

This invention pertains to a method of processing backwash water via the use of a membrane system including a microfiltration membrane or an ultrafiltration membrane.

### BACKGROUND

Backwash water is a wastewater stream generated after the raw water is filtered through a medium such as a media filter, ultrafiltration (UF) membrane, or a microfiltration (MF) membrane and backwashed to remove the accumulated solids from the media filter or UF/MF membrane surface. This backwash water, which is a relatively concentrated stream compared to raw water, contains high levels of contaminants such as suspended solids, colloidal material, bacteria, viruses and other soluble organics. Net water recoveries after media filtration or first stage UF or MF system are about 85-90%, which means 10-15% of feed water is converted into concentrate or backwash water. This water is further treated by second stage UF or MF system to increase the net water recovery to 96-98%. The permeate water recovered from this second stage UF/MF is as clean as from the first stage UF/MF system and can be used in process systems or just as more drinking water. However, due to higher level of contaminants in the backwash water of the first stage UF/MF, the second stage UF/MF system membranes get fouled quickly and have to be operated at lower fluxes than first stage UF/MF system membranes. This results in both higher capital cost (more membranes) and higher operating cost (frequent membrane cleaning). Therefore, it is of interest to minimize membrane fouling in the second stage UF/MF system so that membranes: operate for a longer period between cleanings; operate at a rate of flux in accord with the chosen membrane; operate at higher than currently achievable fluxes; or a combination thereof. In addition, it of interest to lower the number and/or size of the membranes so that capital costs of new systems containing second stage UF/MF membranes for backwash water recovery are lowered.

### SUMMARY OF THE INVENTION

The present invention provides a method of processing backwash water by use of a membrane separation process comprising the following steps: collecting backwash water in a receptacle suitable to hold said backwash water; treating said backwash water with one or more water soluble polymers, wherein said water soluble polymers are selected from the group consisting of: amphoteric polymers; cationic polymers, wherein, said charge density is from about 5 mole percent to about 100 mole percent; zwitterionic polymers; and a combination thereof; optionally mixing said water soluble polymers with said backwash water; passing said treated backwash water through a membrane, wherein said membrane is an ultrafiltration membrane or a microfiltration membrane; and optionally back-flushing said membrane to remove solids from the membrane surface.

### BRIEF DESCRIPTION OF THE DRAWINGS

FIG. 1 illustrates a general process scheme for processing backwash water, which includes a microfiltration membrane/ultrafiltration membrane, wherein the membrane is submerged in a tank, as well as an additional membrane for further processing of the permeate from said microfiltration membrane/ultrafiltration membrane.

FIG. 2 illustrates a general process scheme for processing backwash water, which includes a mixing tank, a clarifier/pre-filter and a microfiltration membrane/ultrafiltration membrane, wherein the membrane is submerged in a tank, as well as an additional membrane for further processing of the permeate from said microfiltration membrane/ultrafiltration membrane.

FIG. 3 illustrates a general process scheme for processing backwash water, which includes a mixing tank, a clarifier/pre-filter and a microfiltration membrane/ultrafiltration membrane, wherein the membrane is external to a feed tank that contains the backwash water, as well as an additional membrane for further processing of the permeate from said microfiltration membrane/ultrafiltration membrane.

FIG. 4 shows flux enhancement with Product-A.

FIG. 5 shows flux enhancement with Product-B.

### DETAILED DESCRIPTION OF THE INVENTION

### Definitions of Terms:

“UF” means ultrafiltration.

“MF” means microfiltration.

“Amphoteric polymer” means a polymer derived from both cationic monomers and anionic monomers, and, possibly, other non-ionic monomer(s). Amphoteric polymers can have a net positive or negative charge. The amphoteric polymer may also be derived from zwitterionic monomers and cationic or anionic monomers and possibly nonionic monomers. The amphoteric polymer is water soluble.

“Cationic polymer” means a polymer having an overall positive charge. The cationic polymers of this invention are prepared by polymerizing one or more cationic monomers, by copolymerizing one or more nonionic monomers and one or more cationic monomers, by condensing epichlorohydrin and a diamine or polyamine or condensing ethylenedichloride and ammonia or formaldehyde and an amine salt. The cationic polymer is water soluble.

“Zwitterionic polymer” means a polymer composed from zwitterionic monomers and, possibly, other non-ionic monomer(s). In zwitterionic polymers, all the polymer chains and segments within those chains are rigorously electrically neutral. Therefore, zwitterionic polymers represent a subset of amphoteric polymers, necessarily maintaining charge neutrality across all polymer chains and segments because both anionic charge and cationic charge are introduced within the same zwitterionic monomer. The zwitterionic polymer is water soluble.

### Preferred Embodiments

As stated above, the invention provides for a method of processing backwash water by use of a microfiltration membrane or an ultrafiltration membrane.

After the backwash water is collected and treated with one or more water-soluble polymers, the backwash water is passed through a membrane. In one embodiment, the membrane may be submerged in a tank. In another embodiment, the membrane is external to a feed tank that contains said backwash water.

In another embodiment, the backwash water that passes through the microfiltration membrane or ultrafiltration membrane may be further processed through one or more membranes. In yet a further embodiment, the additional membrane is either a reverse osmosis membrane or a nanofiltration membrane.

Various backwash water processing schemes would be apparent to one of ordinary skill in the art. In one embodiment, the collected landfill leachate may be passed through one or more filters or clarifiers prior to its passage through an ultrafiltration membrane or a microfiltration membrane. In a further embodiment, the filter is selected from the group consisting of: a sand filter; a multimedia filter; a cloth filter; a cartridge filter; and a bag filter.

The membranes utilized to process backwash water may have various types of physical and chemical parameters.

With respect to physical parameters, in one embodiment, the ultrafiltration membrane has a pore size in the range of 0.003 to 0.1 μm. In another embodiment, the microfiltration membrane has a pore size in the range of 0.1 to 0.4 μm. In another embodiment, the membrane has a hollow fiber configuration with outside-in or inside-out filtration mode. In another embodiment, the membrane has a flat sheet configuration. In another embodiment, the membrane has a tubular configuration. In another embodiment, the membrane has a multi-bore structure.

With respect to chemical parameters, in one embodiment, the membrane is polymeric. In another embodiment, the membrane is inorganic. In yet another embodiment, the membrane is stainless steel.

There are other physical and chemical membrane parameters that may be implemented for the claimed invention.

Various types and amounts of chemistries maybe utilized to treat the backwash water. In one embodiment, the backwash water collected from a media filtration or first stage UF/MF process is treated with one or more water-soluble polymers. Optionally, mixing of the backwash water with the added polymer is assisted by a mixing apparatus. There are many different types of mixing apparatuses that are known to those of ordinary skill in the art.

In another embodiment, these water-soluble polymers typically have a molecular weight of about 2,000 to about 10,000,000 daltons.

In another embodiment, the water-soluble polymers are selected from the group consisting of: amphoteric polymers; cationic polymers; and zwitterionic polymers.

In another embodiment, the amphoteric polymers are selected from the group consisting of: dimethylaminoethyl acrylate methyl chloride quaternary salt (DMAEA.MCQ)/acrylic acid copolymer, diallyldimethylammonium chloride/acrylic acid copolymer, dimethylaminoethyl acrylate methyl chloride salt/N,N-dimethyl-N-methacrylamidopropyl-N-(3-sulfopropyl)-ammonium betaine copolymer, acrylic acid/N,N-dimethyl-N-methacrylamidopropyl-N-(3-sulfopropyl)-ammonium betaine copolymer and DMAEA.MCQ/Acrylic acid/N,N-dimethyl-N-methacrylamidopropyl-N-(3-sulfopropyl)-ammonium betaine terpolymer.

In another embodiment the water soluble polymers have a molecular weight of about 2,000 to about 10,000,000 daltons. In yet a further embodiment, the water soluble polymers have a molecular weight from about 100,000 to about 2,000,000 daltons.

In another embodiment, the dosage of the amphoteric polymers is from about 1 ppm to about 2000 ppm of active solids

In another embodiment, the amphoteric polymers have a molecular weight of about 5,000 to about 2,000,000 daltons.

In another embodiment, the amphoteric polymers have a cationic charge equivalent to anionic charge equivalent ratio of about 3.0:7.0 to about 9.8:0.2.

In another embodiment, the cationic polymers are selected from the group consisting of: polydiallyldimethylammonium chloride (polyDADMAC); polyethyleneimine; polyepiamine; polyepiamine crosslinked with ammonia or ethylenediamine; condensation polymer of ethylenedichloride and ammonia; condensation polymer of triethanolamine and tall oil fatty acid; poly(dimethylaminoethylmethacrylate sulfuric acid salt); and poly(dimethylaminoethylacrylate methyl chloride quaternary salt).

In another embodiment, the cationic polymers are copolymers of acrylamide (AcAm) and one or more cationic monomers selected from the group consisting of: diallyldimethylammonium chloride; dimethylaminoethylacrylate methyl chloride quaternary salt; dimethylaminoethylmethacrylate methyl chloride quaternary salt; and dimethylaminoethylacrylate benzyl chloride quaternary salt (DMAEA.BCQ)

In another embodiment, the cationic polymers have cationic charge between 20 mole percent and 50 mole percent.

In another embodiment, the dosage of cationic polymers is from about 0.1 ppm to about 1000 ppm active solids.

In another embodiment, the cationic polymers have a cationic charge of at least about 5 mole percent.

In another embodiment, the cationic polymers have a cationic charge of 100 mole percent.

In another embodiment, the cationic polymers have a molecular weight of about 100,000 to about 10,000,000 daltons.

In another embodiment, the zwitterionic polymers are composed of about 1 to about 99 mole percent of N,N-dimethyl-N-methacrylamidopropyl-N-(3-sulfopropyl)-ammonium betaine and about 99 to about 1 mole percent of one or more nonionic monomers.

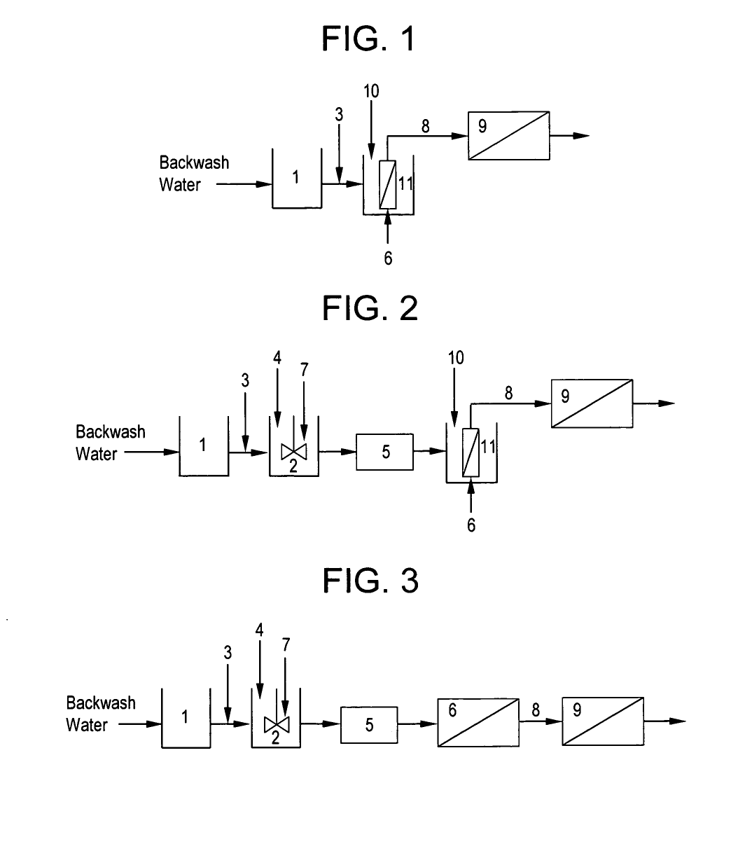

Three potential backwash water processing schemes are shown in FIG. 1 through FIG. 3.

Referring to FIG. 1, backwash water from media filter or first stage UF/MF system is collected in a backwash water receptacle (1). The backwash water then flows through a conduit, wherein said in-line addition (3) of one or more polymers occurs. The treated backwash water then flows into a membrane unit (6) that is submerged in a tank (11). Also, polymer (10) may be added to the tank (11) containing the submerged membrane. The submerged membrane may be an ultrafiltration membrane or a microfiltration membrane. Optionally, the subsequent permeate (8) then flows through an additional membrane (9) that may be either a reverse osmosis membrane or a nanofiltration membrane.

Referring to FIG. 2, backwash water is collected in a backwash water receptacle (1). The backwash water then flows through a conduit, wherein said in-line addition (3) of one or more polymers occurs. The treated backwash water subsequently flows into a mixing tank (2), wherein it is mixed with a mixing apparatus (7), optionally additional polymer (4) is added to the mixing tank (2). The treated backwash water then travels through a pre-filter (5) or clarifier (5). The treated backwash water then flows through a conduit into a membrane unit (6) that is submerged in a tank (11). Optionally polymer (10) may be added to the tank (11) containing the submerged membrane. The submerged membrane may be an ultrafiltration membrane or a microfiltration membrane. Optionally, the subsequent permeate (8) then flows through an additional membrane (9) that maybe either a reverse osmosis membrane or a nanofiltration membrane.

Referring to FIG. 3, backwash water is collected in a backwash water receptacle (1). The backwash water then flows through a conduit, wherein said in-line addition (3) of one or more polymers occurs. The treated backwash water subsequently flows into a mixing tank (2), wherein it is mixed with a mixing apparatus (7), optionally additional polymer (4) is added to the mixing tank (2). The treated backwash water travels through a pre-filter (5) or clarifier (5). The treated backwash water then flows through a conduit into a membrane unit (6), either containing a microfiltration membrane or an ultrafiltration membrane. Optionally the subsequent permeate (8) then flows through an additional membrane (9) that may be either a reverse osmosis membrane or a nanofiltration membrane. The resulting permeate is collected for various purposes known to those of ordinary skill in the art.

In another embodiment, the membrane separation process is selected from the group consisting of: a cross-flow membrane separation process; semi-dead end flow membrane separation process; and a dead-end flow membrane separation process.

The following examples are not intended to limit the scope of the claimed invention.

### EXAMPLES

Membrane performance was studied by turbidity measurements and actual membrane filtration studies on polymer treated backwash water samples. Turbidity was measured by a Hach Turbidimeter (Hach, Ames, Iowa), that is sensitive to 0.06 NTU (Nephelometric Turbidimetric Unit) and membrane filtration studies were conducted in a dead-end filtration stirred cell (Millipore, Bedford, Mass.) with 42 cm² membrane area at 50 rpm stirring speed, 10 psig Trans-membrane pressure (TMP) and 100,000 daltons UF membrane.

### Example 1

Increasing amounts of organic (cationic and anionic) polymers, inorganic products, and a combination of inorganic and organic products were slowly added into a backwash water sample (obtained from a southern US raw water microfiltration plant) in separate jars while mixing with a magnetic stirrer for about 3 minutes. The turbidity of supernatant was measured after the treated solids were settled for 10 minutes in ajar.

TABLE 1
Turbidity of treated and untreated backwash water sample

| | Dosage | Supernatant |
|---|---|---|
| Product | (ppm-active) | Turbidity* (NTU) |
| None | | 525 |
| Product-A (Core Shell | 5.25 | 195 |
| DMAEA.MCQ/AcAm, 50% | | |
| cationic mole charge) | | |
| Product-B | 2.5 | 321 |
| (DMAEA.MCQ/BCQ/AcAm, | | |
| 35% cationic mole charge) | | |
| Product-c | 3.1 | 544 |
| (Aluminum Chlorohydrate + | 1.1 | |
| PolyDADMAC) | | |
| Ferric Chloride | 4.5 | 496 |
| Aluminum Chlorohydrate | 6.25 | 543 |

*After settling for 10 minutes

It is clear from Table 1 that turbidity decreased significantly with cationic organic polymers, but not with cationic inorganic products, or blend of inorganic product and organic polymer.

### Example 2

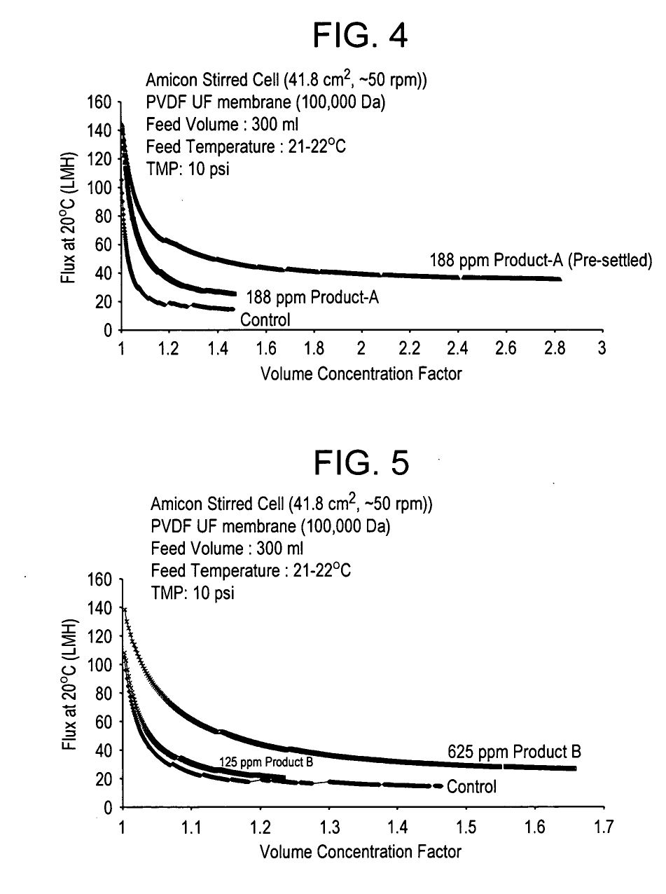

Utilizing the protocol described in Example 1, backwash water treated with Product-A (Core shell DMAEA.MCQ/AcAm) was directly filtered through a UF membrane and the permeate flux monitored as a function of volume concentration factor (“VCF”) (i.e. ratio of Feed volume to Retentate volume). Results are shown in FIG. 4. FIG. 4 also shows the results for filtration of treated and then pre-settled backwash water.

It is apparent from FIG. 4, that at a given volume concentration factor, permeate flux was about 100% higher than control, and after pre-settling of treated solids permeate flux was higher by more than 200% than control.

### Example 3

Utilizing the protocol described in Example 1, backwash water was treated with two different dosages of Product-B (DMAEA.MCQ/BCQ/AcAm) before filtering through a UF membrane. Results are shown in FIG. 5.

It is apparent from FIG. 5 that increasing dosage of Product B resulted in increase in permeate flux, which was about 100% higher than control with 625 ppm product-B, for example, at VCF of 1.3.

1. A method of processing backwash water by use of a membrane separation process comprising the following steps:
a. collecting backwash water in a receptacle suitable to hold said backwash water;
b. treating said backwash water with one or more water soluble polymers, wherein said water soluble polymers are selected from the group consisting of: amphoteric polymers; cationic polymers, wherein, said charge density is from about 5 mole percent to about 100 mole percent; zwitterionic polymers; and a combination thereof;
c. optionally mixing said water soluble polymers with said backwash water;
d. passing said treated backwash water through a membrane, wherein said membrane is an ultrafiltration membrane or a microfiltration membrane; and
e. optionally back-flushing said membrane to remove solids from the membrane surface.

2. The method of claim 1, wherein a driving force for passage of said backwash water through said membrane is positive or negative pressure.

3. The method of claim 1, wherein said ultrafiltration membrane has a pore size in the range of 0.003 to 0.1 μm.

4. The method of claim 1, wherein said microfiltration membrane has a pore size in the range of 0.1 to 0.4 μm.

5. The method of claim 1, wherein said membrane is submerged in a tank.

6. The method of claim 1, wherein said membrane is external to a feed tank that contains said backwash water.

7. The method of claim 1, wherein said membrane is stainless steel.

8. The method of claim 1, wherein the water soluble polymers have a molecular weight of about 2,000 to about 10,000,000 daltons.

9. The method of claim 1, wherein the amphoteric polymers are selected from the group consisting of: dimethylaminoethyl acrylate methyl chloride quaternary salt/acrylic acid copolymer, diallyldimethylammonium chloride/acrylic acid copolymer, dimethylaminoethyl acrylate methyl chloride salt/N,N-dimethyl-N-methacrylamidopropyl-N-(3-sulfopropyl)-ammonium betaine copolymer, acrylic acid/N,N-dimethyl-N-methacrylamidopropyl-N-(3-sulfopropyl)-ammonium betaine copolymer and DMAEA.MCQ/Acrylic acid/N,N-dimethyl-N-methacrylamidopropyl-N-(3-sulfopropyl)-ammonium betaine terpolymer.

10. The method of claim 1, wherein the dosage of the amphoteric polymers are from about 1 ppm to about 2000 ppm of active solids

11. The method of claim 1, wherein the amphoteric polymers have a molecular weight of about 5,000 to about 2,000,000 dalton.

12. The method of claim 1, wherein the amphoteric polymers have a cationic charge equivalent to an anionic charge equivalent ratio of about 3.0:7.0 to about 9.8:0.2.

13. The method of claim 1, wherein the cationic polymers are selected from the group consisting of: polydiallyldimethylammonium chloride;
polyethyleneimine; polyepiamine; polyepiamine crosslinked with ammonia or ethylenediamine; condensation polymer of ethylenedichloride and ammonia;
condensation polymer of triethanolamine an tall oil fatty acid;
poly(dimethylaminoethylmethacrylate sulfuric acid salt); and
poly(dimethylaminoethylacrylate methyl chloride quaternary salt).

14. The method of claim 1, wherein the cationic polymers are copolymers of acrylamide and one or more cationic monomers selected from the group consisting of: diallyldimethylammonium chloride, dimethylaminoethylacrylate methyl chloride quaternary salt, dimethylaminoethylmethacrylate methyl chloride quaternary salt and dimethylaminoethylacrylate benzyl chloride quaternary salt.

15. The method of claim 1, wherein the dosage of cationic polymers are from about 0.1 ppm to about 1000 ppm active solids.

16. The method of claim 1, wherein the cationic polymers have a cationic charge of at least about 5 mole percent.

17. The method of claim 1, wherein the cationic polymers have a cationic charge of 100 mole percent.

18. The method of claim 1, wherein the cationic polymers have a molecular weight of about 500,000 to about 10,000,000 daltons.

19. The method of claim 1, wherein the zwitterionic polymers are composed of about 1 to about 99 mole percent of N,N-dimethyl-N-methacrylamidopropyl-N-(3-sulfopropyl)-ammonium betaine and about 99 to about 1 mole percent of one or more nonionic monomers.

20. The method of claim 1 further comprising passing said backwash water after polymer treatment through a filter or a clarifier prior to said backwash water's passage through said membrane.

21. The method of claim 20, wherein said filter is selected from the group consisting of: a sand filter; a multimedia filter; a cloth filter; a cartridge filter; and a bag filter.

22. The method of claim 1, wherein the membrane separation process is selected from the group consisting of: a cross-flow membrane separation process; semi-dead end flow membrane separation process and a dead-end flow membrane separation process.

23. The method of claim 1 further comprising: passing a filtrate from said membrane through an additional membrane.

24. The method of claim 23, wherein said additional membrane is a reverse osmosis membrane.

25. The method of claim 23, wherein said additional membrane is a nanofiltration membrane.

26. The method of claim 1, wherein said membrane has hollow fiber configuration.

27. The method of claim 1, wherein said membrane has a flat sheet configuration.

28. The method of claim 1, wherein said membrane is polymeric.

29. The method of claim 1, wherein said membrane is inorganic.

30. The method of claim 1, wherein the said water soluble polymers have a molecular weight from 100,000 to about 2,000,000 daltons.

31. The method of claim 1, wherein said membrane has a tubular configuration.

32. The method of claim 1, wherein said membrane has a multi-bore structure.

33. The method of claim 1, wherein cationic polymers have a cationic charge between 20 mole percent and 50 mole percent.
